(19) United States
(12) Patent Application Publication
(10) Pub. No.: US 2025/0363386 A1
(43) Pub. Date: Nov. 27, 2025

(54) DISTRIBUTED LEARNING SYSTEM, MODEL LEARNING APPARATUS, DISTRIBUTED LEARNING METHOD, MODEL LEARNING PROGRAM

(71) Applicant: NIPPON TELEGRAPH AND TELEPHONE CORPORATION, Tokyo (JP)

(72) Inventors: Takumi FUKAMI, Tokyo (JP); Iifan TYOU, Tokyo (JP); Kenta NIWA, Tokyo (JP)

(73) Assignee: NIPPON TELEGRAPH AND TELEPHONE CORPORATION, Tokyo (JP)

(21) Appl. No.: 18/867,140

(22) PCT Filed: May 25, 2022
(86) PCT No.: PCT/JP2022/021390

§ 371 Date: Nov. 19, 2024

(51) Int. Cl. G06N 3/098

(52) U.S. Cl. CPC G06N 3/098

(57) ABSTRACT

A federated learning system includes a plurality of model learning apparatus. Each model learning apparatus is connected to any of the other model learning apparatus via a network. The model learning apparatus includes a mini-batch extraction unit, a model parameter update unit, a dual-variable calculation/transmission unit, a dual-variable reception unit, and a dual-variable setting unit. The model parameter update unit is configured to perform learning using a dual variable, a step size, a mini-batch of model training data, a constraint parameter, and a coefficient γ using a predetermined optimal value n and a predetermined hyperparameter α, thereby updating a model parameter. The dual-variable calculation/transmission unit is configured to calculate and transmit a dual variable using the model parameter updated by the model parameter update unit and a coefficient γ for each other model learning apparatus connected to the model learning apparatus.

### TECHNICAL FIELD

The present invention relates to a federated learning system including a plurality of model learning apparatus, in which each model learning apparatus is connected to any of the other model learning apparatus via a network, a model learning apparatus, a federated learning method, and a model learning program.

### BACKGROUND ART

Many benefits can be expected, such as matching, automatic control, and AI-based medical treatment, using e-mails in personal terminals, purchase history, company review materials, IoT information, hospital diagnosis information, and other data sets. However, those data sets cannot be actively utilized due to concerns about information security and leakage. As a measure to prevent the leakage of confidential information such as personal information, there is federated learning (or distributed learning) for analyzing data on end user terminals and using know-how only (for example, dual variables) without releasing confidential information. NPL 1 discloses a solution to a drift problem in distributed training of machine learning models: gradient correction of stochastic variance reduction (SVR) is implicitly increased by optimally selecting constraint-strength control parameters in the update process of edge-consensus learning (ECL). FIG. 1 shows algorithm 2 illustrated in NPL 1. NPL 2 discloses a solution where the risk of reproducing original data is reduced by adding noise to a learning model (hereinafter simply referred to as a “model”). FIG. 2 shows algorithm 1 and equations 13a and 13b illustrated in NPL 2.

### CITATION LIST

### Non Patent Literature

[NPL 1] Niwa, K., Zhang, G., Kleijn, W. B., Harada, N., Sawada, H., Fujino, A. (2021). Asynchronous Decentralized Optimization With Implicit Stochastic Variance Reduction. Proceedings of the 38th International Conference on Machine Learning, in Proceedings of Machine Learning Research.
[NPL 2] ZonghanH, et al. “Differentially Private ADMM for Convex Distributed Learning: Improved Accuracy via Multi-Step Approximation”, arXiv: 2005.07890.

### SUMMARY OF INVENTION

### Technical Problem

However, although federated learning enables high-speed learning by dispersing the learning into multiple sessions, there is a risk of reproducing the original data using a user-generated model. Moreover, it was unclear to what extent information was exchanged for training machine learning models. Meanwhile, introducing differential privacy into federated learning reduces the risk of reproducing the original data by adding noise to the user-generated model in federated learning. The larger the noise to be added is, the lower the risk of leakage becomes, however also the lower the accuracy of the model to be trained becomes. Existing methods require arbitrary determination of a noise level, leaving the unresolved challenge of reducing the risk of leakage and improving accuracy at the same time.

Further, when training a machine learning algorithm on individual mobile apparatus of users, local datasets owned by users are typically heterogeneous. For example, user A has blood pressure information only, while user B has heart rate information only—in other words, the attributes (labels) of local datasets may vary and have some bias. Additionally, the sizes of datasets may span several orders of magnitude, for example, user A holds datasets of 10 persons but user B has datasets of 3 persons. Since clients involved in federated learning rely on different communication media and different user terminals, computational capabilities and network speed may vary depending on users. The disclosure of NPL 1 also has a challenge that stable federated learning is difficult to perform due to imbalanced distribution of datasets or significant differences in user terminals in terms of computational capabilities and communication efficiency.

Federated learning has several issues and limitations. A first object of the present invention is to implement stable federated learning even when there is imbalanced distribution of datasets or significant differences in user terminals in terms of computational capabilities and communication efficiency.

### Solution to Problem

A federated learning system according to the present invention includes a plurality of model learning apparatus. Each model learning apparatus is connected to any of the other model learning apparatus via a network. In the federated learning system according to the present invention, a model parameter, a dual variable, a step size, model training data, and a constraint parameter are set to predetermined initial values. Each model learning apparatus includes a mini-batch extraction unit, a model parameter update unit, a dual-variable calculation/transmission unit, a dual-variable reception unit, and a dual-variable setting unit. The mini-batch extraction unit is configured to extract a predetermined amount of data as a mini-batch from the model training data. The model parameter update unit is configured to perform learning using a dual variable, a step size, a mini-batch of model training data, a constraint parameter, and a coefficient γ using a predetermined optimal value n and a predetermined hyperparameter α, thereby updating a model parameter. The dual-variable calculation/transmission unit is configured to calculate and transmit a dual variable using the model parameter updated by the model parameter update unit and a coefficient γ for each other model learning apparatus connected to the model learning apparatus. The dual-variable reception unit is configured to receive a dual variable from the other model learning apparatus connected to the model learning apparatus. The dual-variable setting unit is configured to set the received dual variable as a dual variable to be used for the next learning.

### Advantageous Effects of Invention

According to the federated learning of the present invention, the model parameter update unit of the model learning apparatus updates the model parameter with the coefficient γ using a predetermined optimal value n and the predetermined hyperparameter α. Furthermore, the dual-variable calculation/transmission unit calculates and transmits a dual variable using the updated model parameter and the coefficient γ for each other model learning apparatus connected to the model learning apparatus. Since it is adjustable to what extent the model parameters are updated based on the coefficient γ, it is possible to enable stable federated learning even when suffered by imbalanced distribution of datasets or significant differences in user terminals in terms of computational capabilities and communication efficiency.

### BRIEF DESCRIPTION OF DRAWINGS

FIG. 1 is a diagram illustrating algorithm 2 shown in NPL 1.

FIG. 2 is a diagram illustrating algorithm 1 and equations 13a and 13b shown in NPL 2.

FIG. 3 is a diagram illustrating a configuration example of a federated learning system according to Example 1.

FIG. 4 is a diagram illustrating an example in which model learning apparatus of the present invention are connected in a ring shape.

FIG. 5 is a diagram illustrating an example in which model learning apparatus of the present invention are randomly connected.

FIG. 6 is a diagram illustrating an example of a processing flow of the federated learning system according to Example 1.

FIG. 7 is a diagram illustrating a configuration example of a federated learning system proposed by Example 2.

FIG. 8 is a diagram illustrating an example of a processing flow of a federated learning system according to Example 2.

FIG. 9 is a diagram illustrating of an algorithm of a federated learning system 20 according to Example 2 using the same description as in NPL 1.

FIG. 10 is a diagram illustrating a functional configuration example of a computer.

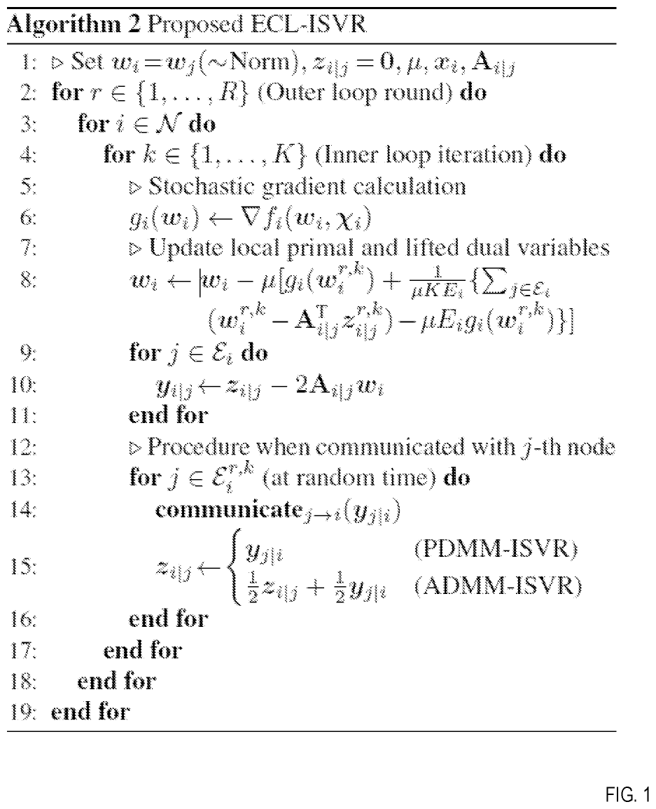

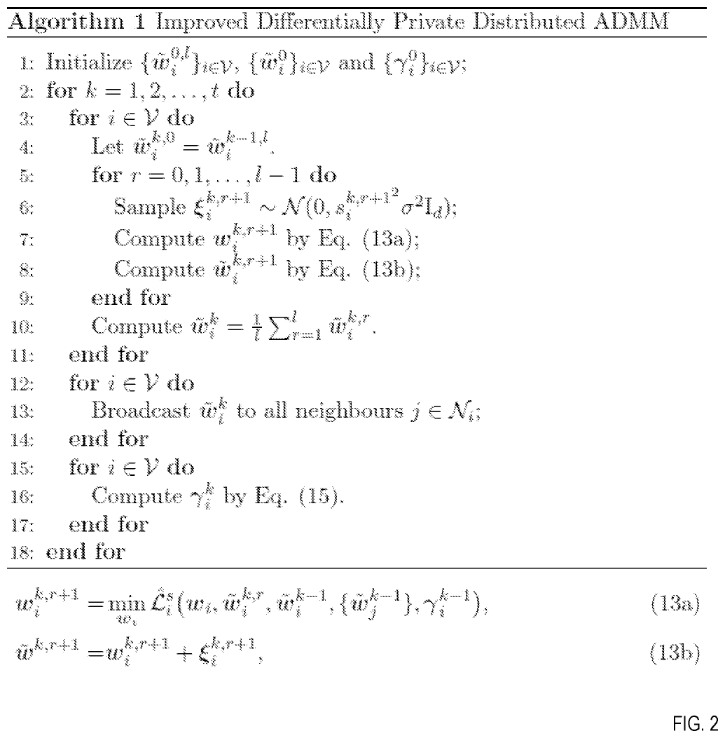

### DESCRIPTION OF EMBODIMENTS

The following describes an embodiment of the present invention in detail. Note that constituent elements having the same functions are denoted by the same reference numerals and redundant explanations thereof will be omitted.

### Example 1

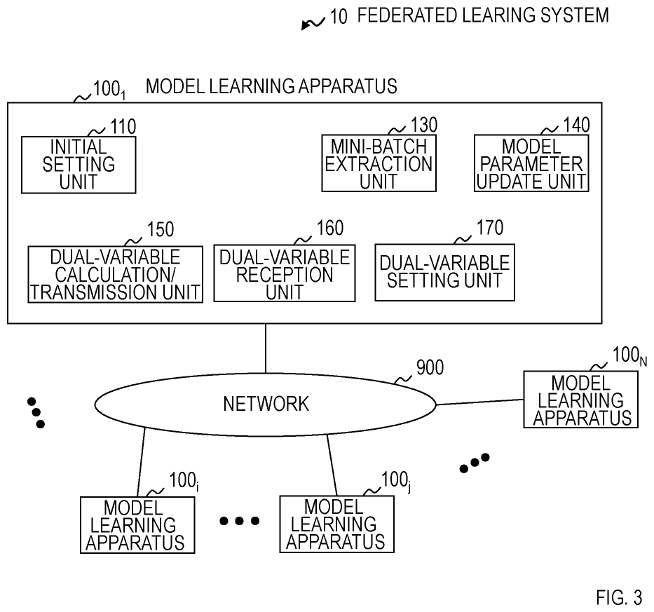

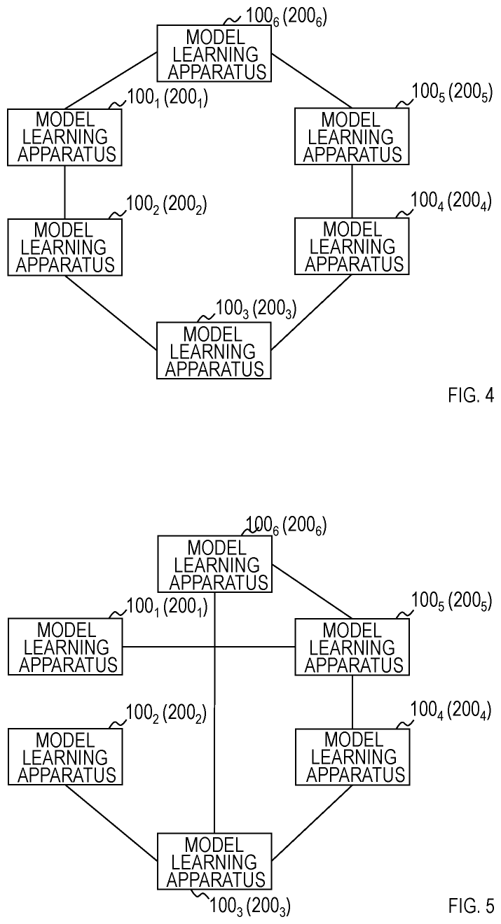

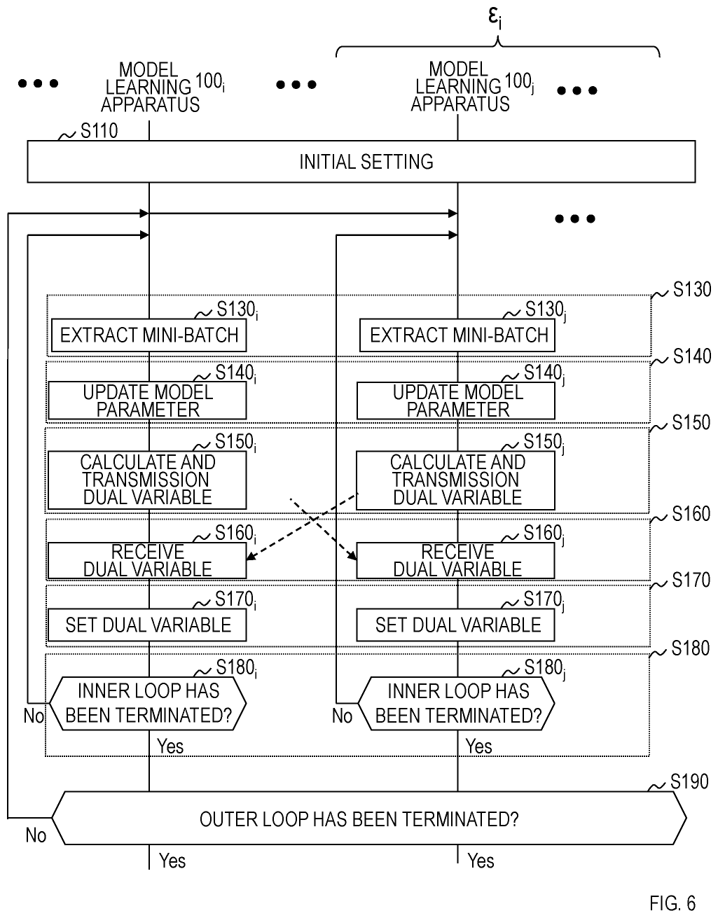

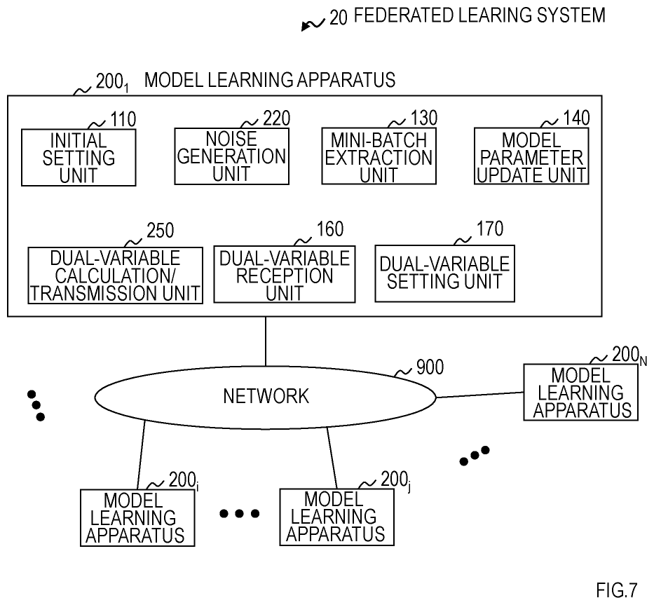

FIG. 3 is a diagram illustrating a configuration example of a federated learning system according to Example 1. FIG. 4 is a diagram illustrating an example in which model learning apparatus of the present invention are connected in a ring shape, and FIG. 5 is a diagram illustrating an example in which model learning apparatus of the present invention are randomly connected. FIG. 6 is a diagram illustrating an example of a processing flow of the federated learning system according to Example 1. A federated learning system 10 of Example 1 includes N model learning apparatus 100₁, . . . , 100_{N}. Each model learning apparatus 100; is connected to any of the other model learning apparatus 100; via a network 900. N is an integer equal to or greater than 2, i is an integer in a range between 1 and N, inclusive, and j is an integer in a range between 1 and N, inclusive, but different from i. Each model learning apparatus 100; includes an initial setting unit 110, a mini-batch extraction unit 130, a model parameter update unit 140, a dual-variable calculation/transmission unit 150, a dual-variable reception unit 160, and a dual-variable setting unit 170.

In the initial setting unit 110 of each of the model learning apparatus 100₁, . . . , 100_{N}, a model parameter wᵢ, a dual variable zᵢⱼ, a step size μ, model training data xᵢ, and a constraint parameter A_{i|j} are set to predetermined initial values (S110). For example, w₁, . . . . w_{N} are set to the same value, while z_{i|j} is set to 0.

The mini-batch extraction unit 130 of each of the model learning apparatus 100₁, . . . , 100_{N} extracts a predetermined amount of data as a mini-batch ξᵢ^{r,k} from the model training data xᵢ (S130). For example, when the pieces of training data are 10,000, 500 or 1000 mini-patches may be arbitrarily extracted. i at the bottom right of ξ indicates the number of the model learning apparatus. k at the upper right of ξ is an integer indicating the number of repetitions of iterative process (inner loop process) performed by each of the model learning apparatus 100₁, . . . , 100_{N}. In the inner loop process, the process is repeated K times. K is an integer of 2 or greater, and k is an integer in a range between 1 and K, inclusive. r at the upper right of ξ is an integer indicating the number of repetitions of iterative process in the inner loop process for the entire federated learning system (outer loop process). In the outer loop process, the process is repeated R times. R is an integer of 2 or greater, and r is an integer in a range between 1 and R, inclusive. In the following explanation as well, i and j at the lower right of the symbol indicate the number of the model learning apparatus, r at the upper right of the symbol indicates the number of repetitions in the outer loop process, and k at the upper right of the symbol indicates the number of repetitions in the inner loop process. For the specification, a lower right symbol and an upper right symbol cannot be placed at the same position in the horizontal direction, so they are deviated. On the other hand, they are placed at the same position in the horizontal direction for mathematical equations and drawings in the specification.

The model parameter update unit 140 of each of the model learning apparatus 100₁, . . . , 100_{N} performs learning using the dual variable, the step size, the mini-batch of model training data, the constraint parameter, and a coefficient γ using a predetermined optimal value n and a predetermined hyperparameter α, thereby updating the model parameter (S140). Specifically, the model parameter update unit 140 updates the model parameter as shown in the following equation, and obtains a model parameter wᵢ^{r,k+1} to be used in the next process.

$${w}_{i}^{r , k + 1} = arg {min}_{u} ( \overline{f} ( u , {ξ}_{i}^{r , k} ) + \frac{η}{2 γ} {\sum }_{j ∈ N} {‖ {A}_{i \vert j} ( u ) - {z}_{i \vert j}^{r , k} ‖}^{2} ) \qquad [ Math . 1 ]$$

wherein f⁻ denotes a cost function or a function that can replace the cost function, u denotes the model parameter before update, ξᵢ^{r,k} denotes the mini-batch of model training data, the coefficient γ is 1+αη, N denotes the number of model learning apparatus constituting the federated learning system, A_{i|j} denotes the constraint parameter, and z_{i|j}^{r} denotes the dual variable. wᵢ^{r,k+1} denotes the model parameter, which refers to k+1-th process in the inner loop. Note that “−” in “f⁻” should be placed above “f”, but due to limitations in the specification, it is written as “f⁻”.

The predetermined optimal value η may be 1/(μKEᵢ). Eᵢ is the number of other model learning apparatus connected to the model learning apparatus 100ᵢ. The predetermined hyperparameter α may be, but not limited to, 2. Since different α is suitable for each federated system, it may be appropriately tailored to each federated learning system. The same functions and parameters as in NPL 1 may be used as f⁻, the cost function or the function that can replace the cost function, the model parameter u, the constraint parameter A_{i|j} and others. For example, the following function qᵢ(wᵢ) described in “4.1. Problem Definition” of NPL 1 may be used as the function f⁻:

$${q}_{i} ( {w}_{i} ) = {f}_{i} ( {w}_{i}^{r , k} ) = 〈 {g}_{i} ( {w}_{i}^{r , k} ) , {w}_{i} - {w}_{i}^{r , k} 〉 + \frac{1}{2 μ} {‖ {w}_{i} - {w}_{i}^{r , k} ‖}^{2} \qquad [ Math . 2 ]$$

wherein, gᵢ denotes a differential function of the cost function fᵢ.

The dual-variable calculation/transmission unit 150 of each of the model learning apparatus 100₁, . . . , 100_{N} calculates and transmits the dual variable γ_{i|j} using the model parameter wᵢ^{r, k+1} updated by the model parameter update unit 140 and the coefficient γ for each other model learning apparatus 100; connected to the model learning apparatus 100ᵢ (S150). Specifically, the dual-variable calculation/transmission unit 150 calculates the dual variable y_{i|j} as shown in the following equation. Note that there is at least one other model learning apparatus 200ⱼ, but there may be two or more. The arrow in the equation means substitution.

$${y}_{i \vert j} ← \frac{1}{γ} \{ ( 1 - αη ) {z}_{i \vert j}^{r , k} - 2 {A}_{i \vert j} ( {w}_{i}^{r , k + 1} ) \} \qquad [ Math . 3 ]$$

The dual-variable reception unit 160 of each of the model learning apparatus 100₁, . . . , 100_{N} receives a dual variable y_{j|i} from the other model learning apparatus 100ⱼ connected to the model learning apparatus 100ᵢ (S160). Since the dual variable y_{j|i} received by the dual-variable reception unit 160 is calculated and transmitted by the dual-variable calculation/transmission unit 150 of the model learning apparatus 100ⱼ, the positions of “j” and “i” are reversed as compared with the dual variable y_{i|j} transmitted by the dual-variable calculation/transmission unit 150.

The dual-variable setting unit 170 of each of the model learning apparatus 100₁, . . . , 100_{N} sets the received dual variable y_{j|i} as a dual variable z_{i|j}^{r,k+1} to be used for the next learning (S170). The dual-variable setting unit 170 may set the received dual variable y_{j|i} as a dual variable z_{i|j}^{r,k+1} to be used for the next learning as shown in the following equation:

$${z}_{i \vert j}^{r , k + 1} ← {y}_{j \vert i} \qquad [ Math . 4 ]$$

Each of the model learning apparatus 100₁, . . . , 100_{N} confirms whether the inner loop process has been terminated, and if it has not been terminated (NO), it continues to repeat the iterative process, and if it has been terminated (YES), proceeds to confirm the outer loop process (S180). When YES for step S180, each of the model learning apparatus 100₁, . . . , 100_{N} confirms whether the outer loop process has been terminated, and if it has not been terminated (NO), it continues to repeat the iterative process, and if it has been terminated (YES), proceeds to terminate the process (S190).

According to the federated learning system 10, the model parameter update unit 140 of the model learning apparatus 100₁, . . . , 100_{N} updates the model parameter wᵢ^{r,k+1} with the coefficient γ using a predetermined optimal value η and the predetermined hyperparameter α. Furthermore, the dual-variable calculation/transmission unit 150 calculates and transmits a dual variable using the updated model parameter and the coefficient γ for each other model learning apparatus 100ⱼ connected to the model learning apparatus 100ᵢ. Since it is adjustable to what extent the model parameters are updated based on the coefficient γ, it is possible to enable stable federated learning even when suffered by imbalanced distribution of datasets or significant differences in user terminals in terms of computational capabilities and communication efficiency.

### Example 2

Example 1 is a solution for the first object of the present invention, i.e. “implementation of stable federated learning even when suffered by imbalanced distribution of datasets or significant differences in user terminals in terms of computational capabilities and communication efficiency”. With additional limitations to the solution for the first object, it is also possible to address another challenge of “reducing a risk of leakage and improving accuracy at the same time”. Therefore, a second object for Example 2 is to “achieve both leakage risk reduction and accuracy improvement”.

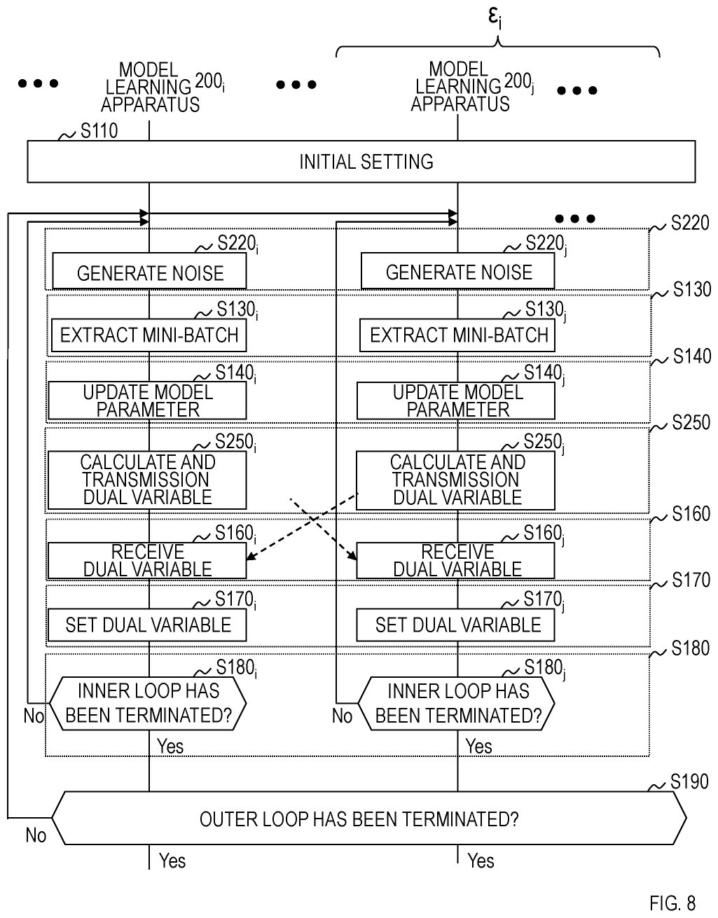

FIG. 7 is a diagram illustrating a configuration example of a federated learning system according to Example 2. FIG. 4 is a diagram illustrating an example in which model learning apparatus of the present invention are connected in a ring shape, and FIG. 5 is a diagram illustrating an example in which model learning apparatus of the present invention are randomly connected. FIG. 8 is a diagram illustrating an example of a processing flow of the federated learning system according to Example 2. A federated learning system 20 of Example 2 includes N model learning apparatus 200₁, . . . , 200_{N}. Each model learning apparatus 200ᵢ is connected to any of the other model learning apparatus 200ⱼ via a network. Each model learning apparatus 200; includes an initial setting unit 110, a noise generation unit 220, a mini-batch extraction unit 130, a model parameter update unit 140, a dual-variable calculation/transmission unit 250, a dual-variable reception unit 160, and a dual-variable setting unit 170.

The processing (S130) of the initial setting unit 110 and the mini-batch extraction unit 130 of each of the model learning apparatus 200₁, . . . , 200_{N} is the same as in Example 1. The noise generation unit 220 of each of the model learning apparatus 200₁, . . . , 200_{N} generates noise nᵢ (S220). Specifically, Gaussian noise nᵢ may be generated based on a predetermined variance σ².

The model parameter update unit 140 of each of the model learning apparatus 200₁, . . . , 200_{N} performs learning using the dual variable, the step size, the mini-batch of model training data, the constraint parameter, and a coefficient γ using a predetermined optimal value n and a predetermined hyperparameter α, thereby updating the model parameter (S140). Specifically, the model parameter update unit 140 updates the model parameter as shown in the following equation, and obtains a model parameter wᵢ^{r,k+1} to be used in the next process.

$${w}_{i}^{r , k + 1} = arg {min}_{u} ( \overline{f} ( u , {ξ}_{i}^{r , k} ) + \frac{η}{2 γ} {\sum }_{j ∈ N} {‖ {A}_{i \vert j} ( u ) - {z}_{i \vert j}^{r , k} ‖}^{2} ) \qquad [ Math . 5 ]$$

wherein f⁻ denotes a cost function or a function can replace the cost function, u denotes the model parameter before update, ξᵢ^{r,k} denotes the mini-batch of model training data, the coefficient γ is 1+αη, N denotes the number of model learning apparatus constituting the federated learning system, A_{i|j} denotes the constraint parameter, and z_{i|j}^{r} denotes the dual variable. wᵢ^{r,k+1} denotes the model parameter, which refers to k+1-th process in the inner loop. The processing of the model parameter update unit 140 is the same as that of Example 1. Since noise is added to the dual variable z_{i|j}^{r} by the dual-variable calculation/transmission unit 250, which will be described later, γ also plays a role in adjusting the influence of noise when updating the model parameter wᵢ^{r,k+1.}

The dual-variable calculation/transmission unit 250 of each of the model learning apparatus 200₁, . . . , 200_{N} calculates and transmits the dual variable y_{i|j} with noise added using the model parameter wᵢ^{r,k+1} updated by the model parameter update unit 140 and the coefficient γ for each other model learning apparatus 200; connected to the model learning apparatus 200₁. Note that there is at least one other model learning apparatus 200ⱼ, but there may be two or more. Specifically, the dual-variable calculation/transmission unit 250 calculates the dual variable y_{i|j} with noise added as shown in the following equation.

$${y}_{i \vert j} ← \frac{1}{γ} \{ ( 1 - αη ) {z}_{i \vert j}^{r , k} - 2 {A}_{i \vert j} ( {w}_{i}^{r , k + 1} + {n}_{i} ) \} \qquad [ Math . 6 ]$$

wherein nᵢ denotes noise generated by the noise generation unit 220. γ of the dual-variable calculation/transmission unit 250 plays the role of adjusting the influence of noise and the role of preventing information leakage.

The processing (S160) of the dual-variable reception unit 160 and the processing (S170) of the dual-variable setting unit 170 are the same as those in Example 1. As in Example 1, the inner loop process is confirmed (S180) and the outer loop process is confirmed (S190), and the iterative process is executed.

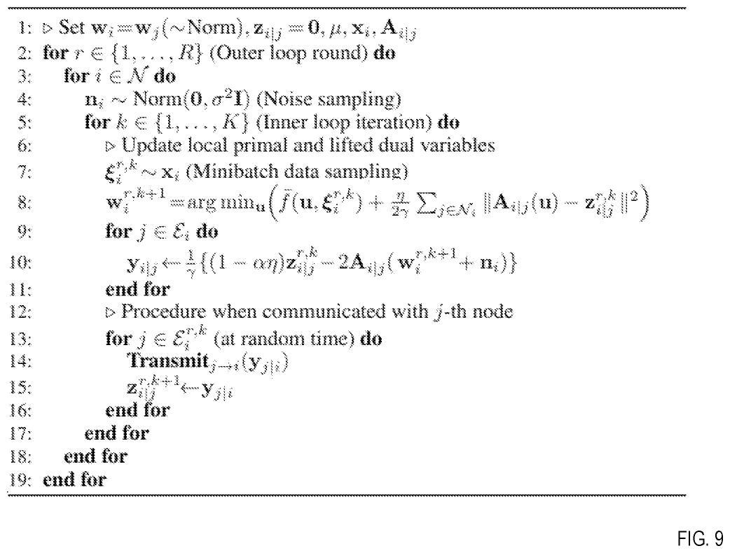

FIG. 9 is a diagram illustrating of algorithm of the federated learning system 20 according to Example 2 using the same description as in NPL 1. According to the federated learning system 20, since no noise is added to ξᵢ^{r,k}, it is possible to reduce the influence of noise that inhibits learning, thereby improving accuracy of model learning. On the other hand, since noise is added to the dual variable y_{i|j} transmitted to other model learning apparatus 200ⱼ, the risk of information leakage can be reduced. Accordingly, it is possible to provide a solution for “achievement of both leakage risk reduction and accuracy improvement”, in addition to the solution for the first object i.e. “implementation of stable federated learning even when suffered by imbalanced distribution of datasets or significant differences in user terminals in terms of computational capabilities and communication efficiency”.

### [Program and Recording Medium]

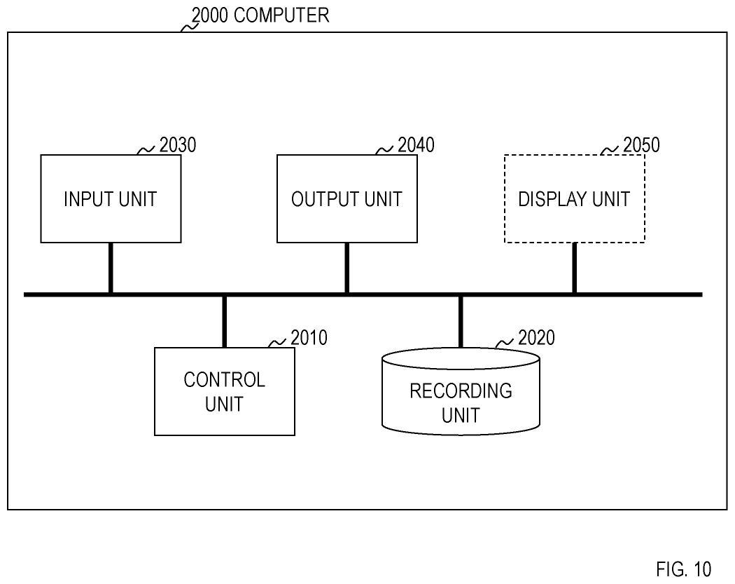

The various types of processing described above can be performed by causing a recording unit 2020 of a computer 2000 shown in FIG. 10 to read a program for executing each step of the above method, and allowing a control unit 2010, an input unit 2030, an output unit 2040, and a display unit 2050 to perform operations.

A program describing this processing can be recorded on a computer-readable recording medium. An example of the computer-readable recording medium may include any recording medium such as a magnetic recording device, an optical disc, a magneto-optical recording medium, and a semiconductor memory.

The program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

The computer that executes such a program first temporarily stores, for example, the program recorded on the portable recording medium or the program transferred from the server computer in a storage device of the computer. Furthermore, when processing is performed, the computer reads the program stored in the own recording medium and performs the processing in accordance with the read program. In addition, as another execution mode of the program, a computer may directly read the program from a portable recording medium and execute processing in accordance with the program. Further, whenever the program is transmitted from the server computer to the computer, the processing may be performed in order in accordance with the received program. Instead of transferring the program from the server computer to the computer, the above-described processing may be executed by a so-called application service provider (ASP) service, in which a processing function is implemented in response to an execution command and in accordance with result acquisition alone. The program in this example includes information to be provided for processing by a computer and information equivalent to the program (data which is not a direct command to the computer but has a property that defines the processing of the computer).

Although the present invention is configured by executing a predetermined program on the computer in this embodiment, at least a part of the processing may be implemented by hardware.

### REFERENCE SIGNS LIST

10, 20 Federated learning system
100,200 Model learning apparatus
110 Initial setting unit
130 Mini-batch extraction unit
140 Model parameter update unit
150, 250 Dual-variable calculation/transmission unit
160 Dual-variable reception unit
170 Dual-variable setting unit
220 Noise generation unit

1. A model learning apparatus constituting a federated learning system including a plurality of model learning apparatus, each model learning apparatus being connected to any of the other model learning apparatus via a network, wherein
a model parameter, a dual variable, a step size, model training data, and a constraint parameter are set to predetermined initial values, and
the model learning apparatus comprising processing circuitry configured to:
extract a predetermined amount of data as a mini-batch from the model training data;
perform learning using a dual variable, a step size, a mini-batch of model training data, a constraint parameter, and a coefficient γ using a predetermined optimal value n and a predetermined hyperparameter α, thereby updating a model parameter;
calculate and transmit a dual variable using the model parameter updated by the model parameter update unit and a coefficient γ for each other model learning apparatus connected to the model learning apparatus;
receive a dual variable from the other model learning apparatus connected to the model learning apparatus; and
set the received dual variable as a dual variable to be used for the next learning.

2. A model learning apparatus constituting a federated learning system including a plurality of model learning apparatus, each model learning apparatus being connected to any of the other model learning apparatus via a network, wherein
a model parameter, a dual variable, a step size, model training data, and a constraint parameter are set to predetermined initial values, and
the model learning apparatus comprising processing circuitry configured to:
generate noise;
extract a predetermined amount of data as a mini-batch from the model training data;
perform learning using a dual variable, a step size, a mini-batch of model training data, constraint parameters, a coefficient γ using a predetermined optimal value η and a predetermined hyperparameter α, thereby updating a model parameter;
calculate and transmit a dual variable with the noise added using the model parameter updated by the model parameter update unit and a coefficient γ for each other model learning apparatus connected to the model learning apparatus;
receive a dual variable from the other model learning apparatus connected to the model learning apparatus; and
set the received dual variable as a dual variable to be used for the next learning.

3. (canceled)

4. The model learning apparatus according to claim 1, wherein
the model parameter wᵢ^{r,k+1} is updated as follows:
$${w}_{i}^{r , k + 1} = arg {min}_{u} ( \overline{f} ( u , {ξ}_{i}^{r , k} ) + \frac{η}{2 γ} {\sum }_{j ∈ N} {‖ {A}_{i \vert j} ( u ) - {z}_{i \vert j}^{r , k} ‖}^{2} )$$
provided that wᵢ^{r,k+1} denotes a model parameter, r denotes the number of repetitions of learning in the entire federated learning system, k denotes the number of learning iterations within the model learning apparatus, i and j each are symbols indicating model learning apparatus, f⁻ denotes a cost function or a function can replace the cost function, u denotes a model parameter before update, ξᵢ^{r,k} denotes a mini-batch of model training data, a coefficient γ is 1+αη, N denotes the number of model learning apparatus constituting the federated learning system, A_{i|j} denotes a constraint parameter, and z_{i|j}^{r} denotes a dual variable, and
the dual variable is calculated as follows:
$${y}_{i \vert j} ← \frac{1}{γ} \{ ( 1 - αη ) {z}_{i \vert j}^{r , k} - 2 {A}_{i \vert j} ( {w}_{i}^{r , k + 1} ) \}$$
provided that y_{i|j} denotes a dual variable.

5. (canceled)

6. The model learning apparatus according to claim 2, wherein
the model parameter wᵢ^{r,k+1} is updated as follows:
$${w}_{i}^{r , k + 1} = arg {min}_{u} ( \overline{f} ( u , {ξ}_{i}^{r , k} ) + \frac{η}{2 γ} {\sum }_{j ∈ N} {‖ {A}_{i \vert j} ( u ) - {z}_{i \vert j}^{r , k} ‖}^{2} )$$
provided that wᵢ^{r,k+1} denotes a model parameter, r denotes the number of repetitions of learning in the entire federated learning system, k denotes the number of learning iterations within the model learning apparatus, i and j each are symbols indicating model learning apparatus, f⁻ denotes a cost function or a function can replace the cost function, u denotes a model parameter before update, ξᵢ^{r,k} denotes a mini-batch of model training data, a coefficient γ is 1+αη, N denotes the number of model learning apparatus constituting the federated learning system, A_{i|j} denotes a constraint parameter, and z_{i|j}r denotes a dual variable, and
the dual variable with noise added is calculated as follows:
$${y}_{i \vert j} ← \frac{1}{γ} \{ ( 1 - αη ) {z}_{i \vert j}^{r , k} - 2 {A}_{i \vert j} ( {w}_{i}^{r , k + 1} + {n}_{i} ) \}$$
provided that y_{i|j} denotes a dual variable with noise added, and nᵢ denotes noise generated by the noise generation unit.

7. A federated learning method using a federated learning system including a plurality of model learning apparatus, each model learning apparatus being connected to any of the other model learning apparatus via a network, wherein
a model parameter, a dual variable, a step size, model training data, and a constraint parameter are set to predetermined initial values,
each model learning apparatus executes an inner loop process a first predetermined number of times, and
each model learning apparatus executes an outer loop process for executing the inner loop process a second predetermined number of times,
in the inner loop process, the federated learning method comprising:
performing learning using a dual variable, a step size, a mini-batch of model training data, a constraint parameter, and a coefficient γ using a predetermined optimal value η and a predetermined hyperparameter α, thereby updating a model parameter;
calculating and transmitting a dual variable using the model parameter updated in the model parameter update step and a coefficient γ for each other model learning apparatus connected to the model learning apparatus;
receiving a dual variable from the other model learning apparatus connected to the model learning apparatus; and
setting the received dual variable as a dual variable to be used for the next learning.

8. A non-transitory computer-readable recording medium on which a program recorded thereon for causing a computer to function as the model learning apparatus according to claim 1.

9. A federated learning system including a plurality of the model learning apparatus according to claim 1, each model learning apparatus being connected to any of the other model learning apparatus.

10. A federated learning system including a plurality of the model learning apparatus according to claim 2, each model learning apparatus being connected to any of the other model learning apparatus.

11. A federated learning method using a federated learning system including a plurality of model learning apparatus, each model learning apparatus being connected to any of the other model learning apparatus via a network, wherein
a model parameter, a dual variable, a step size, model training data, and a constraint parameter are set to predetermined initial values,
each model learning apparatus executes an inner loop process a first predetermined number of times, and
each model learning apparatus executes an outer loop process for executing the inner loop process a second predetermined number of times,
in the inner loop process, the federated learning method comprising:
generating noise;
performing learning using a dual variable, a step size, a mini-batch of model training data, a constraint parameter, and a coefficient γ using a predetermined optimal value η and a predetermined hyperparameter α, thereby updating a model parameter;
calculating and transmitting a dual variable with the noise added using the model parameter updated in the model parameter update step and a coefficient γ for each other model learning apparatus connected to the model learning apparatus;
receiving a dual variable from the other model learning apparatus connected to the model learning apparatus; and
setting the received dual variable as a dual variable to be used for the next learning.

12. A non-transitory computer-readable recording medium on which a program recorded thereon for causing a computer to function as the model learning apparatus according to claim 2.

13. A non-transitory computer-readable recording medium on which a program recorded thereon for causing a computer to function as the model learning apparatus according to claim 4.

14. A non-transitory computer-readable recording medium on which a program recorded thereon for causing a computer to function as the model learning apparatus according to claim 6.
